(19) United States
(12) Patent Application Publication
(10) Pub. No.: US 2021/0153319 A1
(43) Pub. Date: May 20, 2021

(54) PASSIVE THREE-PHASE LIGHT-EMITTING DIODE DRIVERS

(71) Applicant: The University of Hong Kong, Hong Kong (CN)

(72) Inventor: Ron Shu Yuen HUI, Hong Kong (CN)

(21) Appl. No.: 16/621,662

(22) PCT Filed: Jun. 12, 2017
(86) PCT No.: PCT/CN2017/087915

§ 371 Date: Dec. 11, 2019

(51) Int. Cl. H05B 45/37; H05B 45/34; H05B 45/345

(52) U.S. Cl. CPC H05B 45/37; H05B 45/345; H05B 45/34

(57) ABSTRACT

A three-phase LED driver can include: an input voltage having a first phase voltage, a second phase voltage, and a third phase voltage; an input inductor connected to the input voltage; an input capacitor connected between the input voltage and the input inductor; a rectifier connected to the input inductor and having a first terminal and a second terminal; a first capacitor connected between the first terminal and the second terminal of the rectifier; and a filter connected to the first terminal of the rectifier.

### RELATED APPLICATION INFORMATION

This patent claims priority from International PCT Patent Application No. PCT/CN2017/087915, filed Jun. 12, 2017 entitled, “PASSIVE THREE-PHASE LIGHT-EMITTING DIODE DRIVERS” which is incorporated herein by reference in its entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND OF THE INVENTION

The majority of LED drivers are based on traditionally switched mode power electronic technology. Power converters such as flyback, forward or boost converters have been used as controlled current sources for driving LED loads. An example is the ST Microelectronics LED Boost Controller 7708, which uses a boost power converter with the controller for powering LED loads. Traditional switched mode power converters require complex circuitry such as control integrated circuit, electrolytic capacitors for buffering electrical energy and gate drive circuits for controlling the active power switches such as power mosfets [1] and [2]. The requirements of electrolytic capacitors make such approach less reliable because the lifetime of electrolytic capacitors is highly sensitive to temperature. Every 10° C. increase in temperature, the lifetime of electrolytic capacitors will be reduced by half. This is the reason that most of the electronic LED drivers that require electrolytic capacitors are typically 3 to 5 years for indoor applications. For outdoor applications, electronic LED drivers are well known for their vulnerability to lightning and wide temperature variations.

### BRIEF SUMMARY OF THE INVENTION

Embodiments of the subject invention provide a novel and advantageous passive three-phase LED driver including a diode rectifier, a non-electrolytic capacitor for smoothing an output voltage ripple of the diode rectifier, and an output current filter for reducing an output current ripple. Thus, the passive three-phase LED driver of the embodiments of the subject invention operates without an actively controlled power switch, a gate drive circuit, an electrolytic capacitor and a control integrated circuit.

In an embodiment of the present invention, a three-phase LED driver can include: an input voltage having a first phase voltage, a second phase voltage, and a third phase voltage; an input inductor connected to the input voltage; an input capacitor connected between the input voltage and the input inductor; a rectifier connected to the input inductor and having a first terminal and a second terminal; a first capacitor connected between the first terminal and the second terminal of the rectifier; and a filter connected to the first terminal of the rectifier.

In another embodiment of the present invention, a multi-phase passive LED driver can include: an input voltage having a multi-phase voltage; an input LCL 5 circuit connected to the input voltage; a rectifier connected to the input LCL circuit and having a first terminal and a second terminal; a first capacitor connected to the rectifier in parallel through the first terminal and the second terminal; and a filter connected to the first terminal of the rectifier.

In embodiments of the subject invention, the input pulsating power problem of a single-phase system can be solved by using a balanced 3-phase system. The embodiments include an example of the schematic of the 3-phase passive LED driver that can drive at least one LED device. For high power applications, a plurality of LEDs may be connected in series to form an LED string. If necessary, several LED strings can be connected to the output terminals of the proposed LED driver in order to increase the output load power.

### DESCRIPTION OF THE DRAWINGS

FIG. 1 shows a passive LED driving system.

FIG. 2 shows waveforms of input voltage (Vs), input current (Is), Input power (Vs*Is) and output current (Io) of the passive LED driving system of FIG. 1.

FIG. 3 shows a three-phase passive LED driver for LED system according to a first embodiment of the subject invention.

FIG. 4 shows a three-phase passive LED driver according to a second embodiment of the subject invention.

FIG. 5(a) shows a three-phase passive LED driver in case one phase voltage is disconnected.

FIG. 5(b) shows an equivalent circuit of FIG. 5(a).

FIG. 6 shows simulated waveforms of input phase powers, total input power, and an output current ripple of the three-phase passive LED driver of FIG. 3.

### DETAILED DESCRIPTION

Embodiments of the subject invention provide a novel and advantageous passive three-phase LED driver including a diode rectifier, a non-electrolytic capacitor for smoothing an output voltage ripple of the diode rectifier, and an output current filter for reducing an output current ripple.

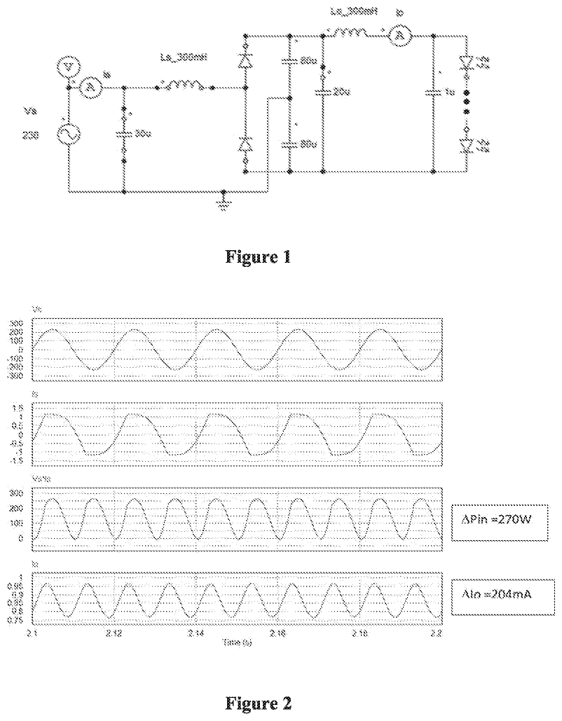

Passive LED drivers have previously been proposed by the inventor in “Apparatus and Methods of Operation of Passive LED Lighting Equipment” [3], and FIG. 1 shows the passive LED driving system. Referring to FIG. 1, the passive LED driving system uses a single-phase input voltage, thus the input power is pulsating if the input power has a high power factor larger than 0.9 (which is a regulatory requirement). Without using an electrolytic capacitor to buffer electrical energy, the single-phase passive LED driving system needs a relatively large alternating current (ac) input inductor Ls and a relatively large direct current (dc) output inductor Lo in order to reduce the output current ripple and the flickering effects of the LEDs.

An example of a 140 W single-phase passive LED driving system of FIG. 1 can be designed for a 230V, 50 Hz power system. FIG. 2 shows typical input voltage, input current, input pulsating power and the output current ripple of the single-phase passive LED driving system of FIG. 1. Referring to FIG. 2, the input power is pulsating. For an output LED load that ideally consumes constant power if no flickering is present, energy storage element must be needed in order to buffer the instantaneous power difference between input pulsating power and constant load power. This is the reason why large input inductor Ls of 300 mH and large output inductor Lo of 300 mH are used in this single-phase LED driving system. The output current has a dc component and an ac ripple. In this example, the averaged dc current is about 0.87 A and the output current ripple is about 0.2 A.

For general street lighting systems, small current ripples may be acceptable because human eyes cannot notice the flickering when the current ripple is small when compared with the average dc current. However, with regard to lighting systems used in sports stadiums and airports, flickering has to be much reduced or even eliminated because live broadcasting cameras and monitoring cameras could detect flickering. Therefore, there is a need to further extend the passive LED driver concept to further reduce the flickering in the passive LED systems.

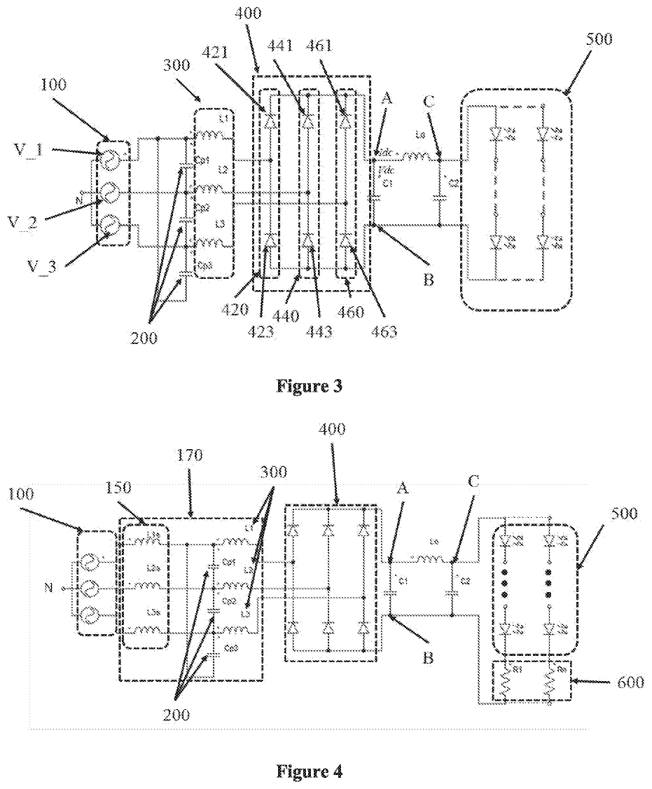

In embodiments of the subject invention, the flickering can be solved by using three-phase input voltage. In addition, the three-phase passive LED driver of the subject invention is robust against lightning and variable temperature, and provides high energy efficiency. FIG. 3 shows a three-phase passive LED driver for LED system according to a first embodiment of the subject invention. Referring to FIG. 3, the three-phase passive LED driver can comprise an input voltage 100, an input inductor 300 connected to the input voltage 100, an input capacitor 200 connected between the input voltage 100 and the input inductor 300, a rectifier 400 connected to the input inductor 300 and having a first terminal A and a second terminal B, a first capacitor C1 connected between the first terminal A and the second terminal B of the rectifier 400, and a filter Lo connected to the first terminal A of the rectifier 400.

The input voltage 100 can comprise a first phase voltage V_1, a second phase voltage V_2, and a third phase voltage V_3. That is, the input voltage 100 provides a three-phase input voltage, but is not limited thereto.

The input inductor 300 can comprise a first input inductor L1 coupled to the first phase voltage V_1, a second input inductor L2 coupled to the second phase voltage V_2, and a third input inductor L3 coupled to the third phase voltage V_3. The first to three input inductors V_1-V_3 limit an input current of the rectifier 400 and thus limit an output current of the rectifier 400 and power for a LED load 500 configured to be connected to the filter Lo through a third terminal C. In addition, the first to three input inductors L1-L3 filter harmonics in the input current of the rectifier 400, thereby improving a distortion factor of the input current.

The input capacitor 200 can comprise a first input capacitor Cp1 connected between the first input inductor L1 and the second input inductor L2, a second input capacitor Cp2 connected between the second input inductor L2 and the third input inductor L3, and a third input capacitor Cp3 connected between the third input inductor L3 and the first input inductor L1. In addition, the first input capacitor Cp1 is connected between the first phase voltage V_1 and the second phase voltage V_2, the second input capacitor Cp2 is connected between the second phase voltage V_2 and the third phase voltage V_3, and the third input capacitor Cp3 is connected between the third phase voltage V_3 and the first phase voltage V_1. The first to third input capacitors Cp1-Cp3 are non-electrolytic capacitors and correct an input power factor of the three-phase passive LED driver.

The rectifier 400 can comprise a first rectifier 420 coupled to the first input inductor L1, a second rectifier 440 coupled to the second input inductor L2, and a third rectifier 460 coupled to the third input inductor L3. The first to third rectifiers 420, 440 and 460 are connected to each other in parallel between the first terminal A and the second terminal B. Thus, the rectifier 400 converts the input current that is an ac current into an output current that is a dc current. That is, the rectifier 400 provides a dc output voltage V_{dc} and a dc output current Ids through the first terminal A.

In particular, the first rectifier 420 includes a first diode 421 connected between the first input inductor L1 and the first terminal A and a second diode 423 connected between the first inductor L1 and the second terminal B. An anode of the first diode 421 is connected to the first input inductor L1 and a cathode of the first diode 421 is connected to the first terminal A. A cathode of the second diode 423 is connected to the first input inductor L1 and an anode of the second diode 423 is connected to the second terminal B. The second rectifier 440 similarly includes a third diode 441 of which an anode is connected to the second input inductor L2 and a cathode is connected to the first terminal A, and a fourth diode 443 of which a cathode is connected to the second input inductor L2 and an anode is connected to the second terminal B. The third rectifier 460 includes a fifth diode 461 connected between the third input inductor L3 and the first terminal A and a sixth diode 463 connected between the third input inductor L3 and the second terminal B.

The first capacitor C1 is connected between the first terminal A and the second terminal B. That is, the first capacitor C1 is connected to the rectifier 400 in parallel, thereby smoothing an output voltage ripple of the dc output voltage V_{dc} of the rectifier 400. The first capacitor C1 is a non-electrolytic capacitor, thereby providing long lifetime and robustness to temperature.

The filter Lo is connected to the first terminal A of the rectifier 400, thereby reducing an output current ripple of the dc output current I_{dc} and a flickering of the LED load 500. The filter Lo is made of an output inductor.

The three-phase passive LED driver can further comprise a second capacitor C2 connected between the third terminal C and the second terminal B. The second capacitor C2 is also connected to the LED load 500 in parallel, thereby providing a conducting path for the dc output current I_{dc} in case the LED load 500 is removed.

In general, the average dc output voltage V_{dc} in the output of the 3-phase diode rectifier can be expressed as:

$${V}_{d c} = 1.35 {V}_{LL} - \frac{3}{π} ω {LI}_{d c} \qquad ( 1 )$$

where V_{LL} is the line-to-line voltage of the 3-phase voltage supply, ω is the angular frequency (i.e 2πf and f is the mains frequency), L is the inductance of the input inductor and I_{dc} is the dc output current of the 3-phase diode rectifier. It is important to note that the input inductor in each phase is not the voltage source reactance. It is a physical inductor deliberately designed to limit the current and therefore power into the LED load.

The dc output voltage V_{dc} is determined from the on-stage voltage across the LED load. If the voltage across a conducting LED package is V_{d} and there are N identical LED packages connected in series to form an LED string, the total voltage across this LED string is appropriately:

For example, if the voltage across each LED package is 6V and there are 20 LED packaged connected in series to form a LED string, the total voltage across this LED string is 120V. If there are M parallel LED strings and the current in each LED string is I_{d}, the total current (I_{dc}) required is:

I_{dc}=MI_{d} (3)

The total LED load power

P_{dc}=V_{dc}I_{dc}=MNV_{d}I_{d} (4)

The input inductor for each phase can be determined by re-arranging equation (1) as:

$$L = \frac{{V}_{d c} - 1.35 {V}_{LL}}{6 {fl}_{d c}} \qquad ( 5 )$$

Using the parameters Cp1=Cp2=Cp3=20 uF, L1=L2=L3=300 mH, C1=100 uF, Lo=100 Mh and C2=1 uF, a simulation has been conducted for a 250 W passive LED system with 3 LED strings (with equal string voltage of 167V). Note that the output inductor is now 100 mH, which is only one-third of that in the single-phase LED system in FIG. 1.

FIG. 4 shows a three-phase passive LED driver according to a second embodiment of the subject invention. Referring to FIG. 4, the input side of the 3-phase passive LED driver can be modified with an input LCL circuit 170 including the input inductor of each phase split into two and with the power factor correction capacitor. The input LCL circuit 170 comprises a pre inductor 150 connected to the input voltage 100, an input capacitor 200 connected to the pre inductor 150, and an input inductor connected between the input capacitor 200 and the rectifier 400. In this arrangement, the input LCL circuit 170 acts as (1) an input filter, (2) power factor correction circuit and (3) current and power limiting circuit for the LED load 500. The LED load 500 comprises at least one LED and may consist of one or more LED strings. In general, a current balancing circuitry 600 may be added if parallel LED strings are used. In the embodiment of FIG. 4, a small series resistor R1 is placed in the 1st LED string. These small series resistors can reduce the current imbalance among the parallel LED strings.

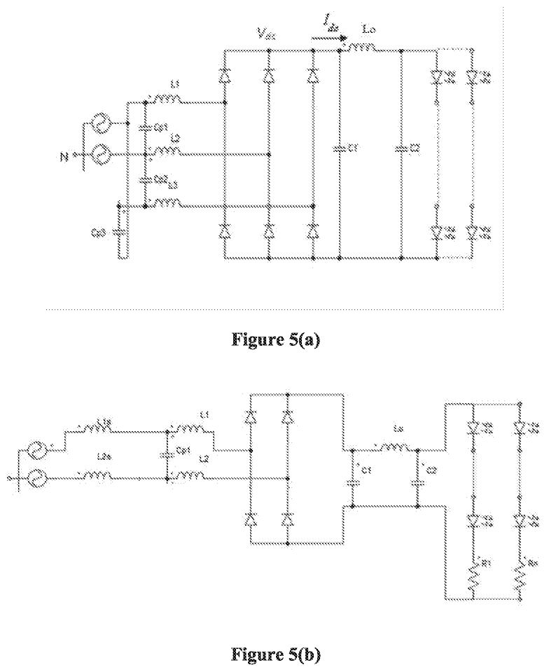

FIG. 5(a) shows a three-phase passive LED driver in case one phase voltage is disconnected and FIG. 5(b) shows an equivalent circuit of FIG. 5(a). As shown in FIGS. 5(a) and 5(b), if one phase voltage is disconnected from the proposed 3-phase circuit, the LED driver can still function like a single-phase circuit fed by the line-to-line voltage of the 3-phase power source. The operation is similar to the single-phase passive LED driver [3], except that the input voltage to the system is the line-to-line voltage. The difference between the proposed 3-phase LED driver fed by a 3-phase power source and a 2-phase power source lies in the current ripple in the LED load. When fed by a 3-phase power source, the LED current ripple will be very small and so the flickering effect is negligible. When fed by a 2-phase power source, the LED current ripple will increase unless larger input inductors (L1, L2 and L3) are used.

### Materials and Methods

All patents, patent applications, provisional applications, and publications referred to or cited herein are incorporated by reference in their entirety, including all figures and tables, to the extent they are not inconsistent with the explicit teachings of this specification. Following are examples that illustrate procedures for practicing the invention. These examples should not be construed as limiting. All percentages are by weight and all solvent mixture proportions are by volume unless otherwise noted.

### Example 1—Three-Phase LED Driver

A three-phase LED driver can include: an input voltage having a first phase voltage, a second phase voltage, and a third phase voltage; an input inductor connected to the input voltage; an input capacitor connected between the input voltage and the input inductor; a rectifier connected to the input inductor and having a first terminal and a second terminal; a first capacitor connected between the first terminal and the second terminal of the rectifier; and a filter connected to the first terminal of the rectifier.

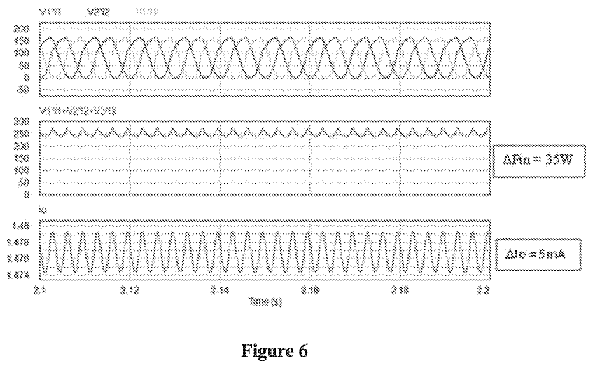

A simulation has been conducted for a 250 W passive LED system with 3 LED strings (with equal string voltage of 167V) by using the parameters Cp1=Cp2=Cp3=20 uF, L1=L2=L3=300 mH, C1=100 uF, Lo=100 mH and C2=1 uF. FIG. 6 shows simulated waveforms of input phase powers, total input power, and the output current ripple of the three-phase passive LED driver of FIG. 3. The output inductor Lo is now 100 mH, which is only one-third of that in the single-phase LED system in FIG. 1.

Referring to FIG. 2 simulating a single-phase passive LED driver and FIG. 6 simulating a three-phase passive LED driver, it can be seen that the input power ripple in the single-phase system is 270 W, while that of the three-phase system is substantially reduced to only 35 W. This reduction of input power ripple is due to the use of the 3 single-phase powers with 120-degree displacement. In addition, the huge reduction in the input power ripple enables a corresponding reduction in the size of the output inductor (acting as filter for the output current). The output inductor Lo in the three-phase system is only 100 mH, while the output inductor Lo of the single-phase system is 300 mH. Moreover, the output current ripple in the single-phase system is 204 mA for an average dc current of 0.87 A (i.e. a ripple to dc current ratio of 0.23), while that in the three-phase system is only 5 mA for an average dc current of 1.47 A (i.e. a ripple to dc current ratio of 0.003). Since flickering effect is proportional to the ripple to dc current ratio, the use of the three-phase passive LED driver can essentially reduce the LED current ripple and flickering effects to a negligible level.

Compared with previously developed single-phase passive LED drivers, the three-phase passive LED drivers in the subject invention have the following advantages: more suitable for high-power applications (e.g. >1000 W); much smaller input power variation and thus smaller energy storage requirements; much smaller output current ripple and therefore negligible flickering; and smaller filter inductor in the output of the diode rectifier.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### REFERENCES

[1] Chinese Patent Application No. 201110062099 “Multichannel Multiphase-driving LED power supply.”
[2] John C. W. Lam, Praveen K. Jain, “A High Power Factor, Electrolytic Capacitor-Less AC-Input LED Driver Topology With High Frequency Pulsating Output Current,” IEEE Transactions on Power Electronics, volume 30, issue 2, February 2015.
[3] Ron Shu Yuen Hui, “Apparatus and Methods of Operation 10 of Passive LED Lighting Equipment,” U.S. Pat. No. 8,482,214.

1. A 3-phase passive LED driving system, comprising:
a 3-phase diode rectifier for converting an input ac current into an output dc current;
one input inductor for each phase for limiting the input current, the output current, and power for an LED load, and filtering harmonics in the input current for improving a distortion factor of the input current;
a non-electrolytic capacitor for smoothing an output voltage ripple of the diode rectifier;
an output current filter for reducing an output current ripple and a flickering of the LED load;
a small non-electrolytic capacitor for providing a conducting path for the output current in case the LED load is removed; and
a plurality of non-electrolytic capacitors for correcting an input power factor of the 3-phase passive LED driving system,

2. The system of claim 1, further comprising at least one LED as the LED load.

3. The system of claim 2, wherein the LED load is connected to output terminals of the 3-phase passive LED driver and is arranged in form of a single string comprising multiple LED connected in series, or in form of several LED strings connected in parallel.

4. The system of claim 3, further comprising a current balancing circuit connected to the parallel LED strings for reducing current imbalance among the parallel LED strings.

5. The system of claim 1, further comprising a plurality of pre inductors connected to the the input inductor and the plurality of non-electrolytic capacitors.

6. The system of claim 1, wherein the system functions to power the LED load in case one phase voltage of a 3-phase power source is disconnected.

7. The system of claim 1, wherein the system functions without an actively controlled power switch.

8. A three-phase light emitting diode (LED) driver, comprising:
an input voltage having a first phase voltage, a second phase voltage, and a third phase voltage;
an input inductor connected to the input voltage;
an input capacitor connected between the input voltage and the input inductor;
a rectifier connected to the input inductor and having a first terminal and a second terminal;
a first capacitor connected between the first terminal and the second terminal of the rectifier;
and a filter connected to the first terminal of the rectifier.

9. The three-phase LED driver according to claim 8, wherein the first capacitor is a nonelectrolytic capacitor.

10. The three-phase LED driver according to claim 9, wherein the input inductor includes a first input inductor coupled to the first phase voltage, a second input inductor coupled to the second phase voltage, and a third input inductor coupled to the third phase voltage.

11. The three-phase LED driver according to claim 10, wherein the rectifier includes a first rectifier coupled to the first input inductor, a second rectifier coupled to the second input inductor, and a third rectifier coupled to the third input inductor.

12. The three-phase LED driver according to claim 11, wherein the first rectifier, the second rectifier, and the third rectifier are connected to each other in parallel between the first terminal and the second terminal.

13. The three-phase LED driver according to claim 12, wherein the input capacitor includes a first input capacitor connected between the first input inductor and the second input inductor, a second input capacitor connected between the second input inductor and the third input inductor, and a third input capacitor connected between the third input inductor and the first input inductor.

14. The three-phase LED driver according to claim 13, wherein the first input capacitor, the second input capacitor, and the third input capacitor are non-electrolytic capacitors.

15. The three-phase LED driver according to claim 12, wherein the input capacitor includes a first input capacitor connected between the first phase voltage and the second phase voltage, a second input capacitor connected between the second phase voltage and the third phase voltage, and a third input capacitor connected between the third phase voltage and the first phase voltage.

16. The three-phase LED driver according to claim 12, wherein the first rectifier includes a first diode connected between the first input inductor and the first terminal and a second diode connected between the first input inductor and the second terminal, the second rectifier includes a third diode connected between the second input inductor and the first terminal and a fourth diode connected between the second input inductor and the second terminal, and the third rectifier includes a fifth diode connected between the third input inductor and the first terminal and a sixth diode connected between the third input inductor and the second terminal.

17. (canceled)

18. (canceled)

19. (canceled)

20. (canceled)

21. (canceled)

22. A multi-phase passive light emitting diode (LED) driver, comprising:
an input voltage having a multi-phase voltage;
an input LCL circuit connected to the input voltage;
a rectifier connected to the input LCL circuit and having a first terminal and a second terminal;
a first capacitor connected to the rectifier in parallel through the first terminal and the second terminal; and
a filter connected to the first terminal of the rectifier.

23. The multi-phase passive LED driver according to claim 2217, further comprising a second capacitor connected to the filter through a third terminal and connected to the second terminal.

24. The multi-phase passive LED driver according to claim 18, wherein the third terminal and the second terminal are configured to be connected to a LED load.

25. The multi-phase passive LED driver according to claim 2419, wherein the LED load is a plurality of parallel LED strings.

26. (canceled)

27. (canceled)

28. (canceled)

29. (canceled)

30. (canceled)

31. (canceled)
